(19) United States
(12) Patent Application Publication
(10) Pub. No.: US 2013/0265213 A1
(43) Pub. Date: Oct. 10, 2013

(54) 3D DYNAMIC DISPLAYER

(71) Applicant: Cheer Chen, Shanghai City (CN)

(72) Inventor: Cheer Chen, Shanghai City (CN)

(73) Assignee: WONDERS OF ART INTERNATIONAL, SHANGHAI CITY (CN)

(21) Appl. No.: 13/996,061

(22) PCT Filed: Nov. 7, 2011
(86) PCT No.: PCT/CN2011/001873

§ 371 Date: Jun. 20, 2013

(30) Foreign Application Priority Data
Dec. 30, 2010 (CN) 201010619347.6

(51) Int. Cl. G09G 5/00

(52) U.S. Cl. CPC G09G 5/003
USPC 345/31

(57) ABSTRACT

A 3D dynamic image display station includes left and right stationary towers (1), and a truss axis disposed on both left and right stationary towers (1) separately and having an elevating device and penetrating through the center positions of a plurality of movable components (2). Both ends of the truss axis are coupled to the elevating device, and a display screen or a medium for projecting an image is disposed on a surface of the stationary tower (1) or the movable component (2). The display screen, the elevating device and the truss axis are coupled to a control system for controlling the display screen to display different images, ascending or descending the movable components (2) along the control system, or rotating the movable components (2) about the truss axis clockwise or counterclockwise for different angles at the same or different time. The 3D dynamic image display station provides a combination of changes according to design requirements.

### FIELD OF THE INVENTION

The present invention relates to a 3D dynamic image display station, in particular to the dynamic image display station capable of providing different types of rotations and displaying different images by the control of a control system.

### BACKGROUND OF THE INVENTION

Most conventional video screens are installed in a fixed manner, and the viewing angle is limited and the application of the screen allows very little variation, so that the application of the screen is restricted.

### SUMMARY OF THE INVENTION

It is a primary objective of the present invention to overcome the aforementioned drawbacks of the prior art by providing a 3D dynamic image display station of the present invention.

To achieve the aforementioned objective, the present invention provides a 3D dynamic image display station comprising two stationary towers, one disposed on the left side and the other disposed on the right side, and each of the two opposite sides having an elevating device, and a truss axis penetrating through the center position of a plurality of movable components, and both ends of the truss axis being coupled to the elevating device, wherein the stationary tower or movable component surface includes a display screen or a medium for projecting images; the display screen, the elevating device and the truss axis are coupled to a control system, so that the display screen can display different images by the control of the control system, or the movable components can be ascended or descended along an elevating system by the control of the control system, or rotated clockwise or counterclockwise about the truss axis for different angles at the same or different time.

Wherein, each movable component has at least one extendable 3D structure, the 3D structure and its surface has the display screen or the medium for projecting an image are connected to the control system, and extending or retracting the 3D structure with respect to the movable components by the control of the control system at the same of different time.

Wherein, the present invention further comprises a rotating platform, and the two stationary towers are disposed on the rotating platform, and the rotating platform includes a rotary rail disposed thereon and connected with the rotating machine unit, and the rotating machine unit drives the rotating platform to rotate clockwise or counterclockwise for different angles under the control of the control system.

Wherein, the rotating platform has the display screen or the medium for displaying an image disposed on a surface of the rotating platform and connected with the control system.

Wherein, the display screen is a light emitting diode (LED) screen.

Wherein, the stationary tower and movable component is a cuboid, a cube or a cylinder.

With the aforementioned technical solutions, the 3D dynamic image display station of the present invention provides a combination of variations and changes as needed to flexibly increase the number of light spots and protects the safety of the operators during the operation process of the image display station effectively.

### BRIEF DESCRIPTION OF THE DRAWINGS

FIG. 1 is a schematic view of the present invention;

FIG. 2 is a schematic view of a preferred embodiment of the present invention;

FIGS. 3A and 3B are schematic views of another preferred embodiment of the present invention; and

FIG. 4 is a schematic view of the rotation of a movable component of the present invention.

### DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

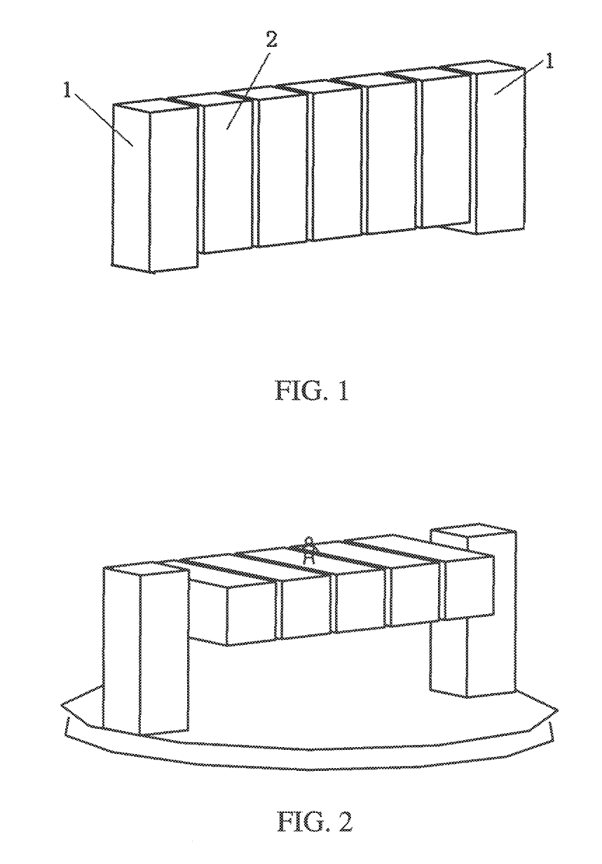

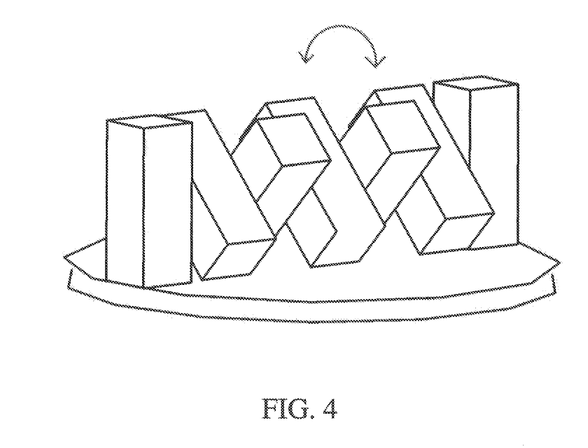

With reference to FIG. 1 for a 3D dynamic image display station of the present invention, the 3D dynamic image display station comprises two stationary towers 1 including a left stationary tower and a right station tower, and each having an elevating device, and a truss axis penetrating through the central positions of a plurality of movable components 2, wherein both ends of the truss axis are coupled to the elevating device. A display screen or a medium (such as a wooden board or a projection screen) for projecting an image is disposed on a surface of the stationary tower 1 or the movable component 2, wherein the display screen can be a light emitting diode (LED) screen, a liquid crystal display (LCD) screen or any other equivalent screen. The display screen, the elevating device and the truss axis are connected to a control system, so that the display screen can display a combination of different images under the control of the control system to allow a variety of contents and the display screen can carry a specific weight or load to allow operators to walk on the surface of the image display station. In FIGS. 2 and 4, the movable components 2 can be ascended or descended along the elevating system at the same or different time under the control of the control system or the movable components 2 can be rotated clockwise or counterclockwise about the truss axis for different angles. Wherein, the elevating device can be ascended or descended and the movable components 2 can be rotated clockwise or counterclockwise by hydraulic, pneumatic, gear-driving or electrical transmission. The quantity of movable components 2 is not limited to any particular number, but it can be changed freely as required.

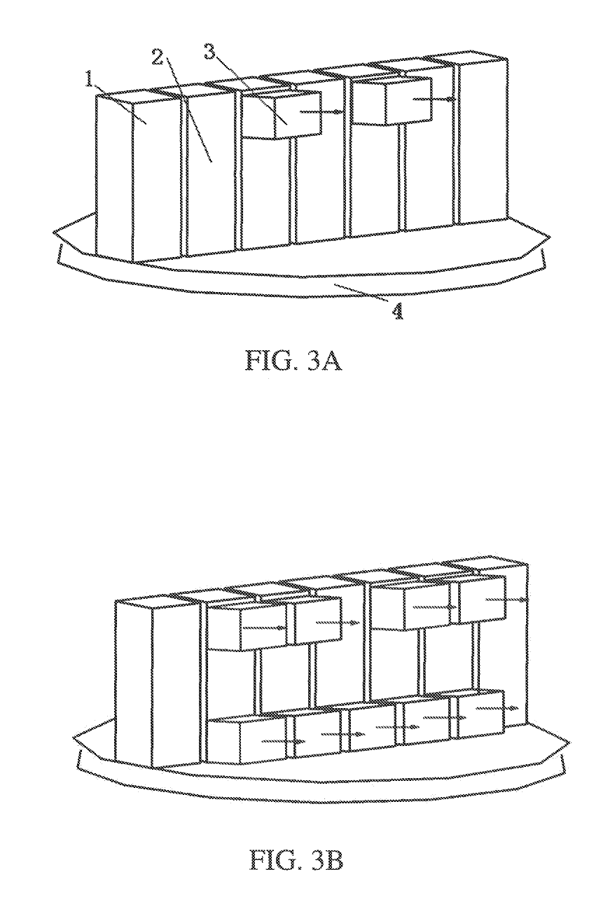

In this preferred embodiment, each movable component 2 has one or more extendable 3D structures 3, and the 3D structure 3 and its surface have the display screen or the medium for projecting an image connected to the control system, so that the 3D structure 3 can be extended or retracted with respect to the movable component 2 simultaneously or separately by the control of the control system as shown in FIGS. 3A and 3B, and the 3D structure 3 can be extended solely or extended with other assemblies altogether, and each 3D structure 3 can carry heavy load or operators. In the present invention, the 3D structure 3 can be designed as a hollow structure, and at least one screen on the surface of the 3D structure 3 can be moved to facilitate its operation and transportation.

In FIGS. 2 to 4, this preferred embodiment further comprises a rotating platform 4, wherein the two stationary towers 1 are disposed on the rotating platform 4, and the rotating platform 4 is disposed on a rotary rail, and the rotary rail has a plurality of guide wheels and connected to a plurality of rotating machine units, so that the rotating platform 4 can be driven and rotated clockwise or counterclockwise together with the rotary rail for different angles under the control of the control system. The rotating machine unit can be installed on an outer side or an inner side of the rotating platform 4 (as needed), and the control system can be installed on the same side of the rotating machine unit (as needed) to control all rotating machine units to rotate synchronously. The control system of this preferred embodiment includes an instruction input module and an execution module, and further includes a mechanical status detection module installed on a side of the machinery and capable of transmitting a position signal to an image player via a cable or wireless transmission to achieve the effect of controlling the change of images automatically. The display screen or the medium for projecting an image is disposed on a surface of the rotating platform 4 and connected to the control system, and the display screen can be a light emitting diode (LED) screen or any other equivalent screen, and the rotating platform 4 has a cross-sectional shape including but not limiting to a circular shape.

In this preferred embodiment, the stationary tower 1 and the movable component 2 are cuboids, cubes or cylinders. Of course, the invention is not limited to such arrangements only, but other equivalent structures can be adopted as required.

In addition, an inclination detector can be installed between both sides of the stationary tower and the movable component 2, so that when the elevating devices on both sides are inclined asynchronously, the inclination detector can sense the condition and transmit a signal to the control system, so that the control system can control and stop the operation of the elevating devices. For safety purposes, the control system is set to a predetermined value, so that when the movable components 2 are situated in a dangerous condition, the operation will be stopped immediately. For example, the height of the truss axis is set to control and determine the operation of movable components 2 and the extendable 3D structures 3 to ensure the safety of the operators.

While the invention has been described by means of specific embodiments, numerous modifications and variations could be made thereto by those skilled in the art without departing from the scope and spirit of the invention set forth in the claims.

1. A 3D dynamic image display station, comprising:
two stationary towers (1), one disposed on the left side, and the other disposed on the right side;
a truss axis, disposed on each of the left and right sides, and having an elevating device, and penetrating through the center positions of a plurality of movable components (2), and both ends of the truss axis being coupled to the elevating device; and
a display screen or a medium for projecting an image, disposed on a surface of the stationary tower (1) or the movable component (2);
wherein the display screen, the elevating device and the truss axis are coupled to a control system for controlling the display screen to display different images, ascending/descending the movable components (2) along the control system, or rotating the movable components (2) about the truss axis clockwise/counterclockwise for different angles at the same or different time.

2. The 3D dynamic image display station of claim 1, wherein each movable component (2) includes a plurality of extendable 3D structures (3) disposed thereon, and the display screen or the medium for projecting an image and disposed on the 3D structure (3) and a surface thereof are connected to the control system, and the control system is provided for controlling the 3D structure (3) to extend or retract with respect to the movable components (2) at the same or different time.

3. The 3D dynamic image display station of claim 1, further comprising a rotating platform (4), and the two stationary towers (1) being disposed on the rotating platform (4), and the rotating platform (4) including a rotary rail disposed thereon, and the rotary rail being connected with the rotating machine unit, and the rotating machine unit driving the rotating platform (4) to rotate clockwise or counterclockwise for different angles under the control of the control system.

4. The 3D dynamic image display station of claim 3, wherein the rotating platform (4) has the display screen or the medium for displaying an image disposed on a surface of the rotating platform (4) and connected with the control system.

5. The 3D dynamic image display station of claim 4, wherein the display screen is a light emitting diode (LED) screen.

6. The 3D dynamic image display station of claim 1, wherein the stationary tower (1) and movable component (2) is a cuboid, a cube or a cylinder.

7. The 3D dynamic image display station of claim 2, further comprising a rotating platform (4), and the two stationary towers (1) being disposed on the rotating platform (4), and the rotating platform (4) including a rotary rail disposed thereon, and the rotary rail being connected with the rotating machine unit, and the rotating machine unit driving the rotating platform (4) to rotate clockwise or counterclockwise for different angles under the control of the control system.

8. The 3D dynamic image display station of claim 7, wherein the rotating platform (4) has the display screen or the medium for displaying an image disposed on a surface of the rotating platform (4) and connected with the control system.

9. The 3D dynamic image display station of claim 8, wherein the display screen is a light emitting diode (LED) screen.
